(19) United States
(12) Patent Application Publication
(10) Pub. No.: US 2015/0281302 A1
(43) Pub. Date: Oct. 1, 2015

(54) Kiosk System for Downloading Media Content

(71) Applicant: Spigot Media Corp., Toronto (CA)

(72) Inventors: Jason Winston, Toronto (CA); Carlos Zamorano, Whitby (CA); Colin M. Reade, Oshawa (CA); Matthew Buscher, San Francisco, CA (US)

(73) Assignee: Spigot Media Corp., Toronto (CA)

(21) Appl. No.: 14/280,528

(22) Filed: May 16, 2014

Related U.S. Application Data
(60) Provisional application No. 61/967,946, filed on Mar. 28, 2014.

(51) Int. Cl. H04L 29/06; H04W 4/02; H04W 12/06

(52) U.S. Cl. CPC H04L 65/60; H04W 12/06; H04W 4/023; H04L 63/0869; H04W 84/12

(57) ABSTRACT

A method, system, and apparatus, including a program encoded on computer-readable medium, for downloading media content files to mobile devices includes downloading media files from local storage on a kiosk to a mobile device over a high-speed wireless communication link using an application on the mobile device. A message can be sent to the mobile device to provide notification of a proximity of the device to a kiosk when a location of the device satisfies predetermined criteria associated with a location of the kiosk, and a download can be initiated after authenticating the device. In addition, a battery charging service for charging the mobile device can be authorized through a charging port of a charging station in response to detecting the installed application on the mobile device. A file can be downloaded from a particular solid state drive in accordance with a file system detected for the device.

### BACKGROUND

This description relates to downloading digital media content, and more particularly to a kiosk system that facilitates access to downloadable media files.

Movies and other media content historically have been available to consumers for personal use on physical media, such as DVDs or VHS tapes. In recent years, such media content is increasingly available for download or in other transferrable forms.

Movies and television programs, for example, are now available for on-demand viewing through computers, set-top boxes associated with television service providers, and consoles that connect to remote servers through the Internet. Some services provide the ability for such media content to be downloaded and stored for subsequent viewing, either through purchase of a perpetual license to view the content or on a rental basis that allows viewing for a limited time. While concerns among content owners over digital piracy have slowed migration toward making transferrable digital media content widely available, digital rights management solutions are available to prevent or substantially preclude widespread problems with digital piracy. Such digital rights management solutions, however, typically limit the types of platforms through which content owners are willing to distribute media content in digital form.

The ability to download or otherwise transfer digital media content is also limited by the amount of bandwidth that is available for downloading or other transfers of files that contain the digital media content. High definition content, for example, requires very large file sizes, which can be time-consuming to download even over typical high-speed residential Internet connections. Wireless transfers of such content to mobile devices in situations where high-speed Wi-Fi networks are unavailable can be even more time-consuming. Even with high-speed networks, transfer speeds can also be limited by bandwidth limitations associated with servers that provide media content download services, particularly for content in high demand or during periods of high activity.

### SUMMARY

In general, one innovative aspect of the subject matter described in this specification can be embodied in methods that include the actions of detecting a location of a mobile device having an installed application, wherein the installed application is associated with a media download system; determining that the location satisfies predetermined criteria associated with a location of a download station of the media download system; sending a message to the mobile device, wherein the message is adapted to cause a notification to be displayed on the mobile device of a proximity of the mobile device to the download station; authenticating the mobile device with the media download system over a wireless local area network supported by the download station; and initiating a download of one or more media files from the download station to the mobile device in response to at least authenticating the mobile device. Other embodiments of this aspect include corresponding systems, apparatus, and computer programs configured to perform the actions of the methods, encoded on computer storage devices.

These and other embodiments can each optionally include one or more of the following features. The location of the mobile device is reported to the media download system using the installed application on the mobile device. The location is detected based on data reported by the installed application over a communication network. The predetermined criteria includes the mobile station being less than a threshold distance between the mobile device and the download station. The message is received by the installed application and the notification is displayed on the mobile device using the installed application. The notification includes information identifying a location of the download station. The installed application is associated with a user account and information associated with the user account identifies media content previously selected by a user of the user account, and one or more media files available on the download station that correspond to media content identified in the information associated with the user account are identified. The message identifies the one or more available media files. Authenticating the mobile device with the media download system over the wireless local area network is performed in response to detecting the mobile device as being within a communication range of the wireless local area network supported by the download station. Initiating a download of one or more media files from the download station to the mobile device is performed in response to receiving a request through the installed application on the mobile device to download one or more selected media files. The installed application is adapted to detect the wireless local area network and identify the wireless local area network as being associated with the media download system. The installed application is provided with access, over the wireless local area network, to metadata associated with media content available on the download station, and a listing of the available media content is displayed on a user interface of the mobile device using the installed application.

In general, one innovative aspect of the subject matter described in this specification can be embodied in systems that include a plurality of download stations and a server system. Each download station includes storage media that store a plurality of media content files, and a wireless local area network router. The server system includes one or more servers adapted to receive location information for a mobile device, using an application installed on the mobile device that is adapted to send the location information to the at least one server; determine whether the location information satisfies predetermined criteria associated with a location of one of the download stations; and send a message to the mobile device, wherein the message is adapted to cause a notification to be displayed on the mobile device of a proximity of the mobile device to the download station. The download station is adapted to download, to a user device, a selected media content file stored on the storage media in response to authenticating the mobile device. Other embodiments of this aspect include corresponding methods, apparatus, and computer programs configured to perform the actions of the methods, encoded on computer storage devices.

These and other embodiments can each optionally include one or more of the following features. The user device comprises the mobile device or a removable media storage device.

In general, one innovative aspect of the subject matter described in this specification can be embodied in computer storage devices encoded with a computer program, wherein the program comprises instructions that when executed by data processing apparatus cause the data processing apparatus to perform operations comprising reporting location information for the data processing apparatus to a server over a wireless network; receiving a message identifying a proximity of a download station in response to the reported location information; displaying a notification of the proximity of the download station on a display screen associated with the data processing apparatus in response to the message; receiving user input through a user interface requesting a download of a selected media content file from the download station; and communicating with the download station to initiate downloading of the selected media content file. Other embodiments of this aspect include corresponding methods, apparatus, and systems.

These and other embodiments can each optionally include one or more of the following features. The program further comprises instructions that when executed by data processing apparatus cause the data processing apparatus to perform operations comprising detecting a local wireless network provided by the download station, wherein communicating with the download station to initiate downloading of the selected media content file is performed using the local wireless network. The program further comprises instructions that when executed by data processing apparatus cause the data processing apparatus to perform operations comprising displaying a listing of media content available on the download station on a user interface.

In general, one innovative aspect of the subject matter described in this specification can be embodied in methods that include the actions of detecting an application installed on a mobile device using a server in communication with the mobile device; identifying a charging port at a charging station for use in charging a battery of the mobile device; and authorizing a battery charging service through the identified charging port for charging the mobile device in response to detecting the installed application on the mobile device. Other embodiments of this aspect include corresponding systems, apparatus, and computer programs configured to perform the actions of the methods, encoded on computer storage devices.

These and other embodiments can each optionally include one or more of the following features. The installed application sends a command to the server to activate the charging service on the charging port. The installed application displays, on a user interface of the mobile device, media content received over a wireless local area network associated with the charging station. Detecting the installed application includes authenticating the installed application with the server. The battery charging service comprises a rapid charging service relative to a charging service provided before authorizing the battery charging service. The charging port is identified based on information received through a user interface provided by the installed application on the mobile device. The charging port is identified based on detecting a connection between the mobile device and the charging station. The application is associated with a digital media content download system. Access through the installed application is provided to metadata identifying media content available on the digital media content download system, wherein the metadata is received on the mobile device through a wireless local area network associated with the charging station.

In general, one innovative aspect of the subject matter described in this specification can be embodied in systems that include a charging station including a plurality of charging ports adapted to charge batteries on mobile devices and a charging server associated with the charging station. The charging server is adapted to confirm whether a mobile device in communication with the charging server has a predetermined application installed on the mobile device; receive an identification of one of the plurality of charging ports from the mobile device; and switch a charging rate on the identified charging port to a faster charging rate in response to confirming that the predetermined application is installed on the mobile device and receiving the identification of the charging port. Other embodiments of this aspect include corresponding methods, apparatus, and computer programs configured to perform the actions of the methods, encoded on computer storage devices.

These and other embodiments can each optionally include one or more of the following features. A wireless local network router is adapted to support communications between the mobile device and the charging server.

In general, one innovative aspect of the subject matter described in this specification can be embodied in methods that include the actions of receiving a request to download selected media content from a download station to a user device; detecting a file system type for the user device after the user device is connected to a panel-mounted port of the download station; identifying one of a plurality of solid state drives storing a media content file corresponding to the selected media content, with each solid state drive connected to a processor of the download station via a transfer bus supporting transfer rates of at least four gigabits per second; transferring the media content file over the corresponding transfer bus to the processor; and transferring the media content file to the user device in accordance with the detected file system type for the user device, wherein the media content file is transferred using a bus connecting the processor to the panel-mounted port and the bus supports a transfer rate of at least three gigabits per second. Other embodiments of this aspect include corresponding systems, apparatus, and computer programs configured to perform the actions of the methods, encoded on computer storage devices.

These and other embodiments can each optionally include one or more of the following features. The request to download selected media content is initiated by a user through an interaction with a web page interface. The web page interface is presented on a display screen of the download station or on a user mobile device. The processor and the solid state drives are secured within a housing of the download station. Transferring the media content file to the user device in accordance with the detected file system type for the user device includes segregating the media content file into blocks selected according to the detected file system type.

In general, one innovative aspect of the subject matter described in this specification can be embodied in systems that include a physically secure housing containing a plurality of solid state storage drives, with each drive storing one or more media content files; a processor connected to each of the solid state storage drives via a high speed transfer bus; a cable connecting the processor to a port adapted to accept a removable storage device, wherein the port is exposed on the outside of the physically secure housing; a wireless local area network router; and a server adapted to provide web documents for display in one of an application on a user device that communicates with the server through the wireless local area network router or a display screen on an exterior of the physically secure housing. The processor is adapted to selectively transfer media content files to a removable storage device inserted in the port and to a mobile device in communication with the wireless local area network router in response to a request to download a media content file to a user device, wherein the request is received from one of an application installed on a user device or a user interface on the exterior of the physically secure housing. Other embodiments of this aspect include corresponding methods, apparatus, and computer programs configured to perform the actions of the methods, encoded on computer storage devices.

In general, one innovative aspect of the subject matter described in this specification can be embodied in methods that include the actions of receiving a request to download selected media content from a download station to a user device through a web page interface provided by a web server included in the download station; detecting at least one of a file system type for the user device or a connection type between the user device and the download station, wherein the download station supports at least two connection types including a wireless data connection type and a removable media connection type; and transferring the media content file to the user device in accordance with at least one of the detected file system type for the user device or the connection type. Other embodiments of this aspect include corresponding systems, apparatus, and computer programs configured to perform the actions of the methods, encoded on computer storage devices.

### DESCRIPTION OF DRAWINGS

FIG. 1 is a block diagram of a media download system.

FIG. 2 is a flow diagram of a method for facilitating media content file downloads based on user location.

FIG. 3 is a block diagram of a mobile device charging system.

FIG. 4 is a flow diagram of a method for authorizing fast battery charging based on installation of an application on a mobile device.

FIG. 5 is a block diagram of a media file management system.

FIG. 6 is a flow diagram of a process for downloading media content files.

FIG. 7 is a block diagram of a media file download kiosk.

Like reference symbols in the various drawings indicate like elements.

### DETAILED DESCRIPTION

In accordance with aspects described in this specification, media content can be wirelessly downloaded to a mobile device from a kiosk. The kiosk can provide access to a library of media content files that can be transferred to a mobile device over a wireless local area network supported by the kiosk. The kiosk can be part of an overall media download system that can include multiple kiosks distributed geographically. The media download system can enable users to interact with the system through web pages and/or through an application installed on a user device. The application or web pages can, among other things, provide information about movies or other media content that are available or that may be available in the future for download through the media download system. For example, users may be able to browse or search a library of media content titles, select certain titles to a “wish list” associated with the respective user's account, and obtain location information for kiosks in the media download system. The wireless local area network supported by a kiosk can provide access to the web pages associated with the media download system and/or can provide access to the library of media content titles (and other metadata associated with media content on the system). In addition, the media file download functionality of the kiosk can be optimized to provide high speed downloads, at least when a mobile device is within a “bubble” around the kiosk (i.e., is close enough to receive a relatively high quality wireless communication signal).

In some implementations, the media download system can support a notification technique through which users can be notified when they are in the vicinity of a kiosk. Such a notification can be provided through the application installed on a mobile device (e.g., running in the background) and can provide location information and/or directions to the nearby kiosk. In some cases, such notifications can be dependent upon whether the kiosk stores media files corresponding to media content identified in the user's wish list. Such notifications can encourage use of the media download system and can increase convenience for users of the system.

Kiosks can include or can be located near battery charging stations that can be used to charge mobile device batteries, for example, while a user waits for media content files to download from the kiosk to the user's mobile device. To encourage installation of the application, users can be invited to install the application on their mobile devices to receive rapid charging services for their mobile device batteries. For example, the charging station may include charging ports (e.g., USB charging ports or device-specific charging cables) that generally provide a trickle charging capability to mobile devices, while devices that have the application installed can be used to unlock rapid charging services on a charging port to which such a device is connected or on a charging port designated by a user through a user interface in the application.

In general, the kiosks store media content files in a local storage array to facilitate bandwidth independence. In other words, speeds for downloading media content files from a kiosk to a mobile device are not dependent upon bandwidth for downloading the files from a remote server. Instead, by storing the files on a local storage array, the download speeds are limited only by the memory access speeds associated with the local storage array and a mobile device and the wireless communication speeds supported by the wireless local area network and the mobile device. By optimizing the hardware and software associated with the kiosk and the wireless local area network, the kiosk can be capable of download speeds that effectively make the mobile device capabilities the only limiting factors on the speed with which files can be downloaded. For example, the local storage array can include a plurality of solid state drives with very fast read speeds to enable media content files to be read very quickly when requested for download to a mobile device. Each drive can store a portion of the overall available library of media content files and can be connected to a motherboard that includes a high speed bus port for each drive. Thus, media content files can be transferred from the drives to the motherboard over a high speed bus (e.g., that supports transfer speeds over 4 gigabits per second). The motherboard can further include one or more ports that attach, via another high speed bus (e.g., using USB 3.0 Super Speed technology), to a panel mounted connector (e.g., cable or port) for connecting mobile devices for a fast download of media content files to a removable drive attached to the panel mounted connector. Using this configuration, end users have access to the panel mounted connector and user interface components (e.g., a touch screen display on the kiosk), while the drives, motherboard, and bus cables can be housed within a secure enclosure that prevents unauthorized physical access to the major components of the kiosk.

The kiosk can be configured to deliver media content files to user devices over a local wireless network or through a removable drive connector on the kiosk. Downloads can be request through a user interaction with a web interface presented on either the display screen of the kiosk or through an application on a mobile device. Depending on the type of connection, media content files can be routed by the motherboard to either the panel mounted connector or to a wireless router. The download process can be performed based on the detected type of connection. For example, media content files can be downloaded via a wireless router using an HTTP (hypertext transfer protocol) session (e.g., to a smartphone) or via a native copy function of the operating system for the motherboard to a removable media connected to the panel mounted connector. The download process can also be tailored based on the type of file system used on the device to which the file is to be downloaded. For example, the file can be segregated into smaller blocks to facilitate faster or proper file downloads.

A process can be implemented to manage the library of media content files stored on the kiosks throughout the media download system. In some implementations, it may be desirable to maintain the same media content files on all of the kiosks. In other implementations, it may be desirable to customize the available files by location (e.g., if there tend to be different interest levels in certain media content at different kiosk locations). Some kiosks may have access to sufficient Internet bandwidth such that new media content files can be downloaded to the local storage array (e.g., during off hours, such as overnight). Kiosks may also be updated with new media content files by physically replacing drives that store content. A kiosk management administrative subsystem can be used to select new media files to be made available in the media download system and to track which kiosks have the latest update and which kiosks need to be updated. As updates are selected for inclusion in the media download system, other (e.g., older or less popular) media content files can be selected for removal. An administrative user interface on the kiosk management administrative subsystem can be used to select files to be added and removed and individual storage drives in the memory array of each kiosk can be identified for updating (e.g., over the Internet) or manual replacement (e.g., by physically removing a drive and inserting a drive with the desired updates).

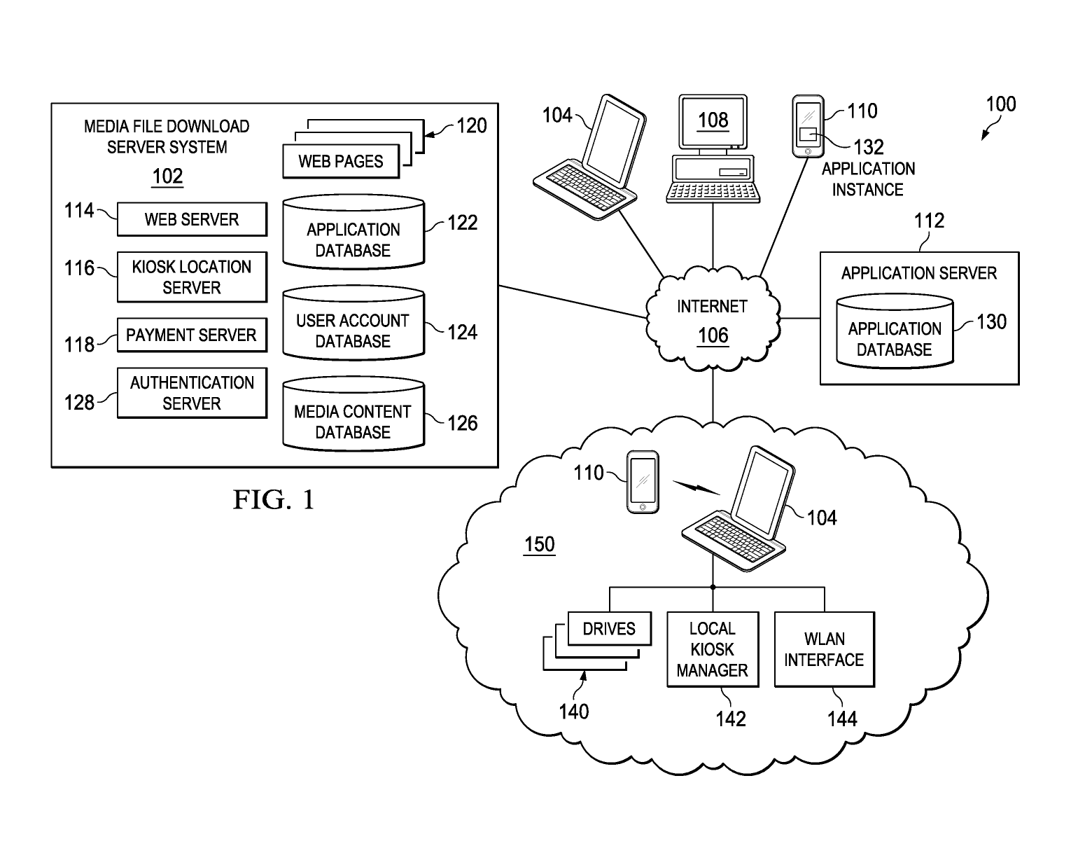

FIG. 1 is a block diagram of a media download system 100. The system 100 includes a media file download server system 102 and a plurality of kiosks 104 that communicate over a network 106 (e.g., the Internet). Users can access the system 100 through user devices 108 (e.g., desktop computers) and mobile devices 110 (e.g., smart phones, tablets, and laptops) using either a web interface or an application associated with the system 100. The user devices 108 and mobile devices 110 can download and install the application from an application server 112, which may be supported by one or more third party application hosting services. The application server 112 can include an application database 130 that stores one or more versions of an application associated with the media file download server system 102. For example, different versions of the application may be stored for use with different operating systems.

The media file download server system 102 includes a web server 114, a kiosk location server 116, and a payment server 118. Users can access web pages 120 from a user device 108 (or from a mobile device 110) by communicating with the web server 114 over the network 106. The web pages 120 can provide functionalities that allow users to create an account, store user preferences, browse or search for media content, and store an identification of desired media content in a wish list. User account information, preferences, and a user wish list can be stored in a user account database 124 of the media file download server system 102. A library of currently available media content titles and other media content titles expected to be available in the future can be stored in a media content database 126 of the media file download server system 102. In addition, the media content database 126 can store additional metadata associated with the media content titles, including, for example, cast, director, rating, duration, and images (e.g., cover art) for a movie or other program that is available or that may be available in the future through the system 100. Accordingly, users can search or browse the titles and other metadata stored in the media content database 126 through a web page 120 and can select media content titles for addition to the user's wish list, which is stored in the user account database 124.

Users can also download and install an application to a mobile device 110 (or a user device 108) by communicating with the application server 112 over the network 106. An installed application instance 132 on a mobile device 110 can provide the same or similar functionality as the web pages 120. For example, the installed application instance 132 can communicate over the network 106 with the web server 114 to create a user account, update user account preferences, browse and search media content titles and metadata, and select media content titles for addition to the user's wish list. In general, the installed application instance 132 can provide a basic framework for presentation of data, while the data content can be provided from an application database 122 and the media content database 126 of the media file download server system 102. In addition, at least some user data (e.g., preferences and/or wish list selections) can also be stored locally by the installed application instance 132 on the mobile device 110.

Each kiosk 104 includes a storage array 140 that includes a plurality of individual storage drives that store media content files corresponding to the available media content titles identified in the media content database 126 of the media file download server system 102. In some implementations, the media content files can also be stored at the media file download server system 102 (e.g., for use in updating the media content files stored locally at the kiosks or downloading the media content files to user devices 108 through private WiFi access points). In addition, each kiosk includes a local kiosk manager 142, which can provide at least some of the same services as the media file download server system 102 (e.g., the ability to browse and search media content titles and metadata, functions provided by the web server 114 such as serving web page interfaces to mobile devices 110 through a web browser or the installed application instance 132 or to a display screen on the kiosk 104). In addition, the local kiosk manager 142 can facilitate download transactions with mobile devices 110 to enable users to purchase or rent and download media content. Each kiosk 104 also includes a wireless local area network interface 144 (e.g., a WiFi interface) that enables communication between the kiosk 104 and mobile devices 110 in a local area around the kiosk 104.

After the application is installed on a mobile device 110, the application can periodically report a location of the mobile device 110 to the media file download server system 102. The location can be determined using any suitable locating functions of the mobile device (e.g., a satellite-based positioning system such as a global position satellite (GPS) system or triangulation of cellular transmissions) and can be reported over the network 106 and/or a cellular communication network. The kiosk location server 116 can compare the location of the mobile device 110 to known locations of kiosks 104 to determine whether the location is within a predetermined threshold distance from a kiosk 104. The threshold distance can be pre-assigned for all kiosks or can be different for different kiosks 104 and can be the same for all users or can be defined according to user preferences stored in the user account database 124 of the media file download server system 102. In addition, the kiosk location server 116 can also apply other criteria in addition to location. For example, other criteria can include whether the kiosk 104 currently stores content media files in the user's wish list, whether the mobile device is located within a mall or other facility where the kiosk 104 is located, and/or a current speed of the mobile device (e.g., to avoid providing notifications if the user is traveling at a high rate of speed down the highway). The kiosk location server 116 can evaluate the criteria to determine whether to provide a notification of the nearby kiosk 104 to the mobile device 110.

If the kiosk location server 116 determines that a notification of the nearby kiosk 104 should be provided, the media file download server system 102 can send a message over the network 106 to the installed application instance 132 on the mobile device 110. The message can cause the installed application instance 132 (e.g., as it is running in the background on the mobile device 110) to display a notification on the mobile device 110 that a kiosk 104 is in the vicinity. The notification can also prompt the user to open the installed application instance 132 to provide additional information, including, for example, detailed location information for the nearby kiosk 104, directions to the nearby kiosk 104, and/or an identification of media content titles on the user's wish list that are available for download on the kiosk 104.

When the mobile device 110 is carried within communication range (indicated by 150) of the kiosk 104 (with or without previously being notified of a nearby kiosk 104), the installed application instance 132 can detect transmissions from the wireless local area network for the kiosk 104 and can display a notification on a user interface of the mobile device 110 of the close proximity of the kiosk 104. This notification can again prompt the user to open the installed application instance 132. Authentication of the installed application instance 132 with an authentication server 128 of the media file download server system 102 can be initiated either automatically and/or the user can be prompted to enter authentication credentials. The installed application instance 132 can provide a listing of media content files available for download (e.g., corresponding to the titles on the user's wish list). If the user selects one or more media content files for download, the local kiosk manager 142 can initiate the download process, which can include obtaining payment information from the user through the installed application instance 132. The payment information can be pre-stored in the installed application instance 132, pre-stored in the user account database 124, or can be entered by the user through a user interface provided on the mobile device 110 by the installed application instance. The local kiosk manager 142 can interact with the payment server 118 of the media file download server system 102 to obtain pre-authorization for the transaction. Once pre-authorization is obtained, the local kiosk manager 142 provides a unique uniform resource locator (URL) to the installed application instance 132 for initiating downloading of the media content file from the storage array 140 to the mobile device 110. To provide additional security, the URL can be changed for every unique download of the media content file to prevent unauthorized reuse of the URL. After the download is complete, the local kiosk manager 142 can communicate with the installed application instance 132 to confirm that the download was successful. If success is confirmed, the local kiosk manager 142 can instruct the payment server 118 to complete the payment transaction (e.g., through a credit card payment system, by deducting from a balance associated with the user account, or through a small transaction payment system such as PayPal™). The user account database 124 can also be updated to reflect that the content media file was successfully downloaded.

In some implementations, media content files can also be downloaded through a physical connection to the kiosk with either the mobile device 110 or a removable media storage device. Downloads through a physical connection can be authorized through the installed application instance 132 on a mobile device 110 or through a user interaction with the kiosk 104 through one or more user interfaces on the kiosk 104 (e.g., touch screen menu).

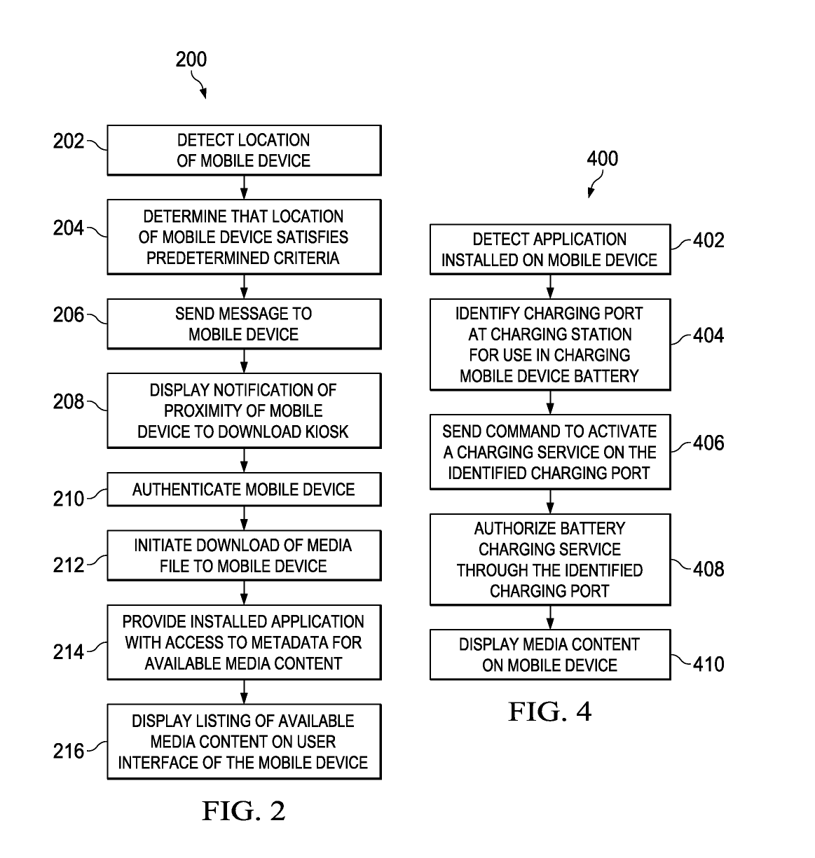

FIG. 2 is a flow diagram of a method 200 for facilitating media content file downloads based on user location. The method 200 includes detecting (at 202) a location of a mobile device that includes an installed application associated with a media download system. The location can be detected, for example, using locating techniques native to the mobile device or to a cellular network in communication with the mobile device and can be reported using the installed application. A determination is made (at 204) that the location satisfies predetermined criteria associated with a location of a download kiosk of the media download system. For example, it can be determined whether the mobile station is within a threshold range of the download kiosk. A message is sent to the mobile device (at 206) regarding the proximity of the download kiosk. In response to the message, a notification to be displayed (at 208) on the mobile device (e.g., by the installed application) of a proximity of the mobile device to the download kiosk. For example, the notification can indicate a location of the download kiosk. The notification can also identify media content available on the download kiosk that the user previously indicated interest in (e.g., in a wish list stored in association with a user account). The mobile device is authenticated with the media download system over a wireless local area network supported by the download kiosk (at 210). For example, the mobile device can be authenticated in response to detecting that the mobile device is within a communication range of the wireless local area network supported by the download kiosk. A download of one or more media files from the download kiosk to the mobile device is initiated (at 212) in response to at least authenticating the mobile device. In some implementations, initiating the download is further in response to receiving a request through the installed application on the mobile device to download the one or more media files. The installed application is also provided (at 214) with access, over the wireless local area network, to metadata associated with media content available on the download kiosk. A listing of the available media content is displayed (at 216) on a user interface of the mobile device using the installed application.

To facilitate the techniques described above for providing notification of a nearby download kiosk and encouraging users to download media files, the application on the mobile device can be adapted to report location information for the mobile device to a server over a wireless network; receive a message identifying a proximity of a download station in response to the reported location information; display a notification of the proximity of the download station on a display screen of the mobile device in response to the message; detect a local wireless network provided by the download station; receive user input through a user interface requesting a download of a selected media content file from the download station; communicate with the download station to initiate downloading of the selected media content file (e.g., using the local wireless network); and display a listing of media content available on the download station on a user interface.

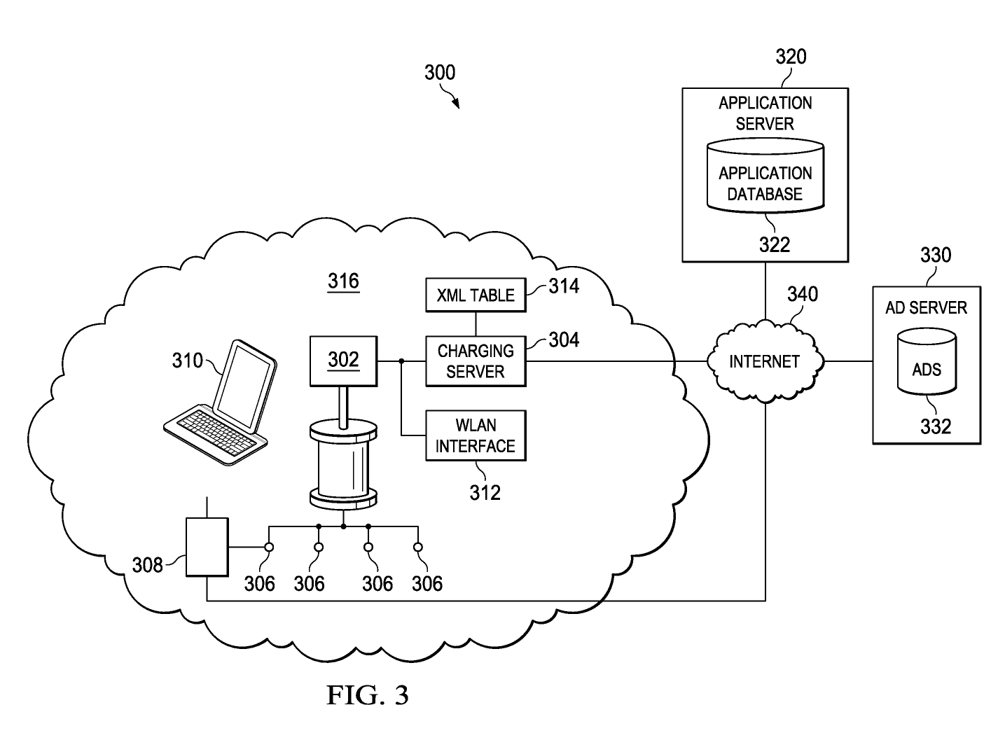

FIG. 3 is a block diagram of a mobile device charging system 300. The system 300 includes a mobile device battery charging station 302 that includes a charging server 304. The charging station 302 includes a plurality of charging ports 306 that can be used to charge batteries in mobile devices 308. In some implementations, when a mobile device 308 is connected to a charging port 306, the charging station 302 can provide a trickle charge (e.g., a charge similar to what is provided through a USB port on a computer). Users can be prompted, however, to download an application to obtain access to rapid charging services (e.g., similar to what is provided by plugging the device into an AC outlet). Users can be prompted, for example, by a display at the charging station identifying the application and encouraging the user to download the application over a network 340 from an application server 320 that stores one or more versions of the application in an application database 322. In some implementations, the charging station 302 can be in close proximity (as indicated by 316) to, or incorporated into, a kiosk 310, which may be a kiosk 104 described in connection with FIG. 1. Similarly, the application can correspond to the application described in connection with FIG. 1. The application can include additional functionality, however, to enable unlocking access to rapid charging services.

Once the application is installed on the mobile device 308 (either at the time the application is installed or at a subsequent time), the application can display a user interface on the mobile device that prompts the user to plug into a charging port 306 on the charging station 302, enter an identification of a port number for the selected charging port 306, and enable wireless local area network communications on the mobile device 308. Using a connection with a wireless local area network interface 312 of the charging station 302, the application can send a message to the charging server 304 to switch the charging port 306 having the identified port number to a rapid charging state. In response, the charging server 304 activates rapid charging on the identified port number. The charging server 304 can maintain a table 314 (e.g., an XML table) that stores the charging state for each charging port 306 and can update the table 314 to reflect that the identified port number is in a rapid charging state. The application can detect that rapid charging is activated (e.g., through the operating system of the mobile device 308 or by receiving a message from the charging server 304) and can display a notification of the rapid charging state on a user interface of the mobile device 308. In some implementations, the application can also connect to an advertising server 330 to retrieve an advertising feed from an advertising database 332. Alternatively, the charging server 304 can connect to the advertising server 330 and retrieve an advertising feed to push to the application for display on a user interface of the mobile device 308. In addition, in some implementations, the application can be used to access metadata regarding digital media content available through the digital media content system described in connection with FIG. 1.

In some implementations, instead of requesting that the user enter the charging port number, the charging server 304 can communicate with the application on the mobile device 308 to identify the port number. For example, when the mobile device is plugged into a charging port 306, the application can send a message to the charging server 304, which can detect which charging port the mobile device is connected to based on timing of detecting the connection to the charging port relative to timing of the message received from the application. Alternatively, in some implementations, the application can send a message to the charging server 304 through the charging port connection, which may include, for example, a sequence of turning on and off the charging function of the mobile device. In some implementations, a message sent by the application to the charging server 304 can include an authentication key that uniquely identifies the installed application instance to enable the charging server to determine that the installed application is a valid instance of the application.

FIG. 4 is a flow diagram of a method 400 for authorizing fast battery charging based on installation of an application on a mobile device. An application installed on a mobile device is detected (at 402) using a server in communication with the mobile device. A charging port at a charging station for use in charging a battery of the mobile device is identified (at 404). The charging port can be identified based on information received through a user interface provided by the installed application on the mobile device. Alternatively, the charging port can be identified based on detecting a connection between the mobile device and the charging station. A command is sent (at 406) to the server (e.g., by the installed application) to activate the charging service on the charging port. For example, the charging service can be a rapid charging service relative to a charging service provided before authorizing the battery charging service. A battery charging service through the identified charging port is authorized (at 408) for charging the mobile device in response to detecting the installed application on the mobile device. Media content received over a wireless local area network associated with the charging station is displayed (at 410) (e.g., through the installed application) on a user interface of the mobile device during the charging process.

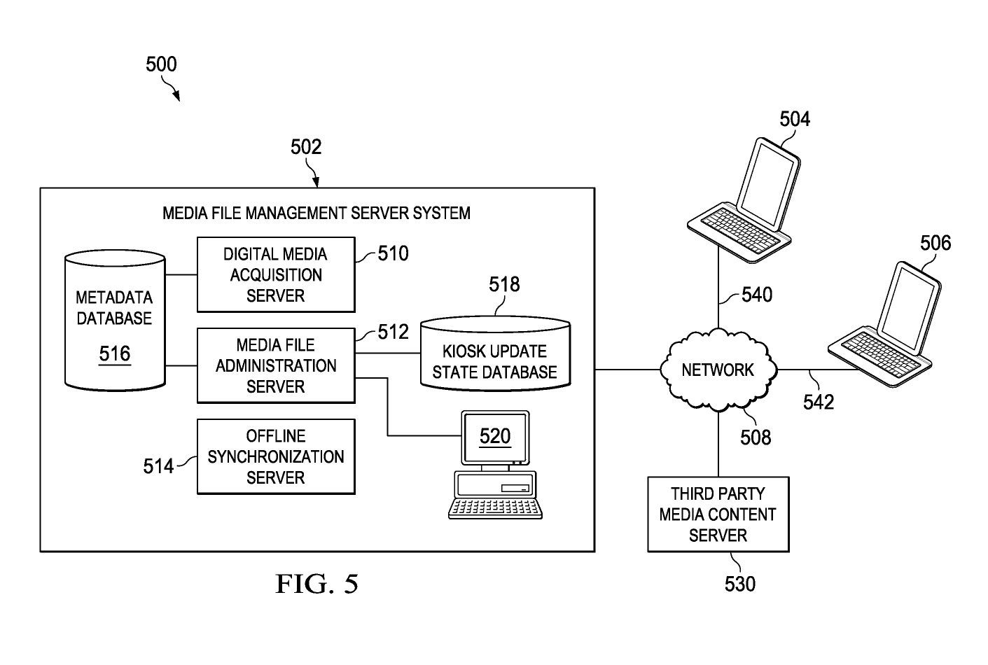

FIG. 5 is a block diagram of a media file management system 500. The system 500 includes a media file management server system 502 that is used to manage updating of media files on content media kiosks 504 and 506, such as the kiosks described in connection with FIG. 1. The media file management server system 502 includes a digital media acquisition server 510 that serves as middleware between a media file download server system and one or more third party media content servers 530 (e.g., servers associated with movie studios for use in deploying digital content). In addition, the media file management server system 502 includes a media file administration server 512 and an offline synchronization server 514. The digital media acquisition server 510 periodically requests metadata associated with new content from the third party media content servers 530 over a network (e.g., a wide area network such as the Internet). If new content is available from one or more third party media content servers 530, the digital media acquisition server 510 retrieves the associated metadata from the appropriate third party media content servers 530 and stores the retrieved metadata in a metadata database 516. The metadata can include, for example, title, cast, director, rating, duration, and images (e.g., cover art) associated with the new media content. As part of the storage process, the digital media acquisition server 510 can also parse the metadata and perform other processing such as resizing images as appropriate for use in the media file management server system 502 and/or the media file download server system 102 of FIG. 1.

An administrator can access an administrative user interface hosted by the media file administration server 512 through a computer 520 to periodically review new content for potential deployment in the kiosk environment (i.e., so that the content can be downloaded through one or more kiosks 504 and 506). The administrative user interface allows the administrator to view the metadata associated with the new content, select new content to be deployed to kiosks 504 and 506, and identify publishing dates for the new content. An identification of new content that is selected for deployment to the kiosks is stored (e.g., in the metadata database 516) and periodically retrieved by the digital media acquisition server 510. In addition, the administrative user interface allows the administrator to identify media content files currently stored on a drive of the kiosks 504 and 506 that are to be deleted (i.e., removed from the library of available downloads currently on the kiosks). When new content is identified as having been selected for deployment, the digital media acquisition server 510 generates a kiosk metadata download file (e.g., in JSON format) that includes metadata to be stored for the media content in the kiosks 504 and 506.

Kiosk updating can be divided into a master kiosk update phase and a slave kiosk update phase. In general, a master kiosk 504 is a kiosk that can communicate with the media file management server system 502 over a high speed communication link 540 (e.g., such that new content can be loaded onto the kiosk from a remote location), while a slave kiosk 506 is a kiosk that has a less reliable communication link 542 (e.g., such that new content is deployed by physically exchanging drives on the slave kiosks 506). As master kiosks 504 are updated with the master kiosk metadata download file, the update state of the kiosks 504 is stored in the kiosk update state database 518.

During the master kiosk update phase, a database in each master kiosk 504 is updated with the kiosk metadata download file. If media content files are selected to be deleted from the kiosks 504 and 506, the media files are deleted from the appropriate master kiosks to potentially make room for the new content files. If such deletions make room for new content, the new content files can be stored on a drive with sufficient storage space. Otherwise, the new content files are stored on a new or previously unused drive in the master kiosk 504. In either case, the new media content files are retrieved by the digital media acquisition server 510 and loaded onto the appropriate drive of the master kiosk 504 and the kiosk update state database 518 is updated accordingly.

In the slave kiosk update phase, an offline synchronization server 514 identifies media content files to be stored on a replacement drive that will be physically exchanged with existing drives in the slave kiosks 506. In general, the offline synchronization server 514 identifies media content files such that the replacement drive replicates the drives in the master kiosks 504. The kiosk update state database 518 is updated to reflect that the slave kiosk is to be updated with a replacement drive and instructions are provided to a technician, who can then manually exchange the replacement drive (or drives) in the slave kiosk 506 with the appropriate existing drive that is to be replaced. In addition, a database in the slave kiosk 506 is updated with the kiosk metadata download file. In some implementations, the database in the slave kiosk 506 can be updated over the communication link 542. In other implementations, the database can be updated manually by a technician. Once the replacement drives are inserted into the slave kiosk 506, the slave kiosk 506 can send a communication to the media file administration server 512 to update the kiosk update state database 518 to reflect that the replacement is complete.

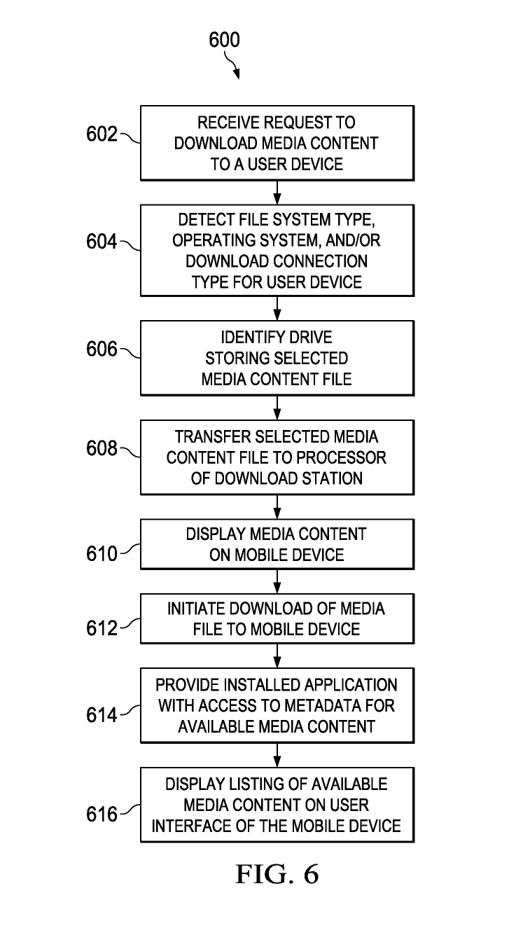

FIG. 6 is a flow diagram of a process 600 for downloading media content files. A request to download selected media content from a download station to a user device is received (at 602). For example, the request to download selected media content can be initiated by a user through an interaction with a web page interface presented on a display screen of the download station or on a user interface of a user's mobile device. The web page interface can be provided by a web server included in the download station. A file system type, operating system, and/or download connection type (e.g., a wireless data connection type or a removable media connection type) for the user device is detected (at 604) after the user device is connected to a panel-mounted port of the download station. One of multiple solid state drives storing a media content file corresponding to the selected media content is identified (at 606). In some implementations, each solid state drive is connected to a processor of the download station via a transfer bus supporting transfer rates of at least four gigabits per second. The media content file is transferred (at 608) over the corresponding transfer bus to the processor. The media content file is transferred (at 610) to the user device in accordance with the detected file system type, the operating system, and/or the download connection type for the user device. For example, the media content file can be transferred to the user device in accordance with the detected file system type for the user device by segregating the media content file into blocks selected according to the detected file system type. In some implementations, the media content file is transferred using a bus connecting the processor to the panel-mounted port and the bus supports a transfer rate of at least three gigabits per second.

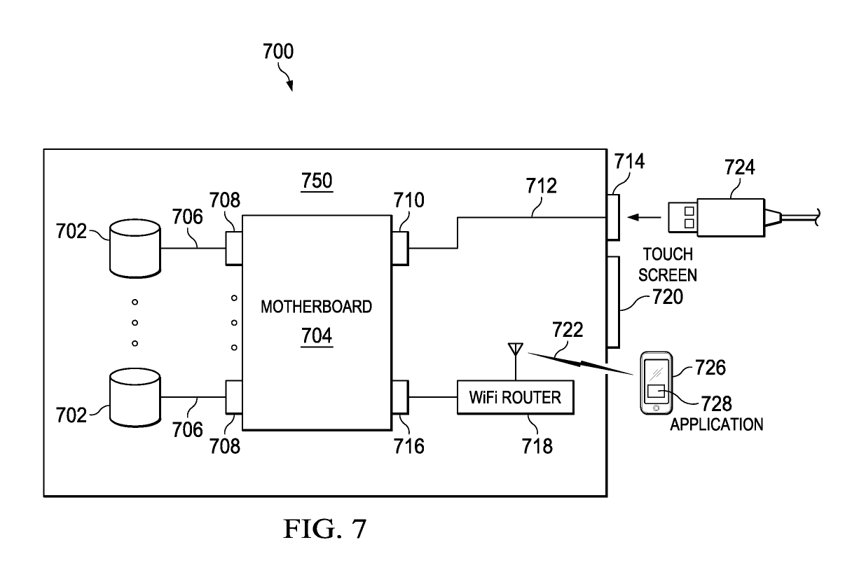

FIG. 7 is a block diagram of a media file download kiosk 700. The download kiosk 700 includes a plurality of storage drives 702 with high speed read capabilities. For example, the storage drives 702 can be solid state drives that offer very fast read speeds but slower write speeds to better facilitate fast downloads to users. Each storage drive 702 can be connected to a motherboard 704 (e.g., that includes a central processing unit, memory, etc.) via a high speed transfer bus 706 that connects to a dedicated port 708 for the corresponding storage drive 702 and transfer bus 706. For example, the transfer bus 706 can be a SATA III bus that supports 6 gigabit per second transfer speeds or some other high speed transfer bus (e.g., that supports transfer speeds in excess of 4 gigabits per second). Another port 710 on the motherboard 704 can further connect to a panel mounted connector 714 (e.g., a USB port) via a high speed transfer bus 712, which may be a lower speed transfer bus than the transfer bus 706 but may still offer transfer speeds in excess of three megabits per second. For example, the motherboard 704, the transfer bus 712, and the panel mounted connector 714 can support USB 3.0 Super Speed technology. The motherboard 704 may further include a port 716 that connects to a local area wireless network router 718. The storage drives 702, motherboard 704, transfer buses 706 and 712, ports 708, 710, and 716, and wireless network router 718 can be contained within a secure (e.g., metal) enclosure 750 that protects the equipment from unauthorized access. The panel mounted connector 714, however, can be accessible on the exterior of the kiosk 700 for end users to use for high speed downloading of media content files. The outside of the kiosk may also include a touch screen display 720 that allows users to interact with the kiosk 700 and/or users can interact through an application on a mobile device 726.

When a user requests a download from the kiosk 700, instructions executable on the motherboard 704 can determine (or the request from the user can specify) whether the download is to be performed across a wireless connection 722 or to a removable media device 724. The motherboard 704 can manage the download process accordingly. For example, the motherboard 704 can route downloads over a wireless connection to the wireless network router 718 after establishing a communication session with the appropriate mobile device 726. Moreover, the motherboard 704 can perform the transfer using hypertext transfer protocol, with the application 728 on the mobile device 726 managing receipt and storage of the media content file. For downloads to a removable drive 724, the motherboard 704 can route downloads to the panel mounted connection 714 after confirming (e.g., through a manual user response and/or through a script that detects a connected removable storage device) that the user has inserted the removable drive 724 into the panel mounted connector 714. Moreover, the motherboard 704 can perform the transfer using ha native copy function of the operating system on the motherboard 704. For example, the motherboard 704 can create a folder on the connected removable storage device 724 and copy the selected media content file to that folder.

Instructions executable on the motherboard 704 can further operate to manage the download process according to the type of file system used by at least a physically connected removable storage device 724. Different types of file systems may need to be managed differently to obtain the fastest download or to successfully perform a download. For example, media content files to be transferred to a removable thumb drive that uses NTFS or a FAT32 file system may need to be broken into smaller chunks or blocks for performing the transfer. In addition, for wireless transfers, some types of operating systems may require special handling either to limit the size of the file or to split the file into multiple pieces, which could be rejoined in a single file by an application on the client side. Accordingly, the motherboard 704 can test for the type of file system and/or operating system on the mobile device 726 or removable storage device 724 to which a media content file is to be downloaded and can serve the file to the device accordingly.

Implementations of the subject matter and the functional operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions tangibly stored on a computer readable storage device for execution by, or to control the operation of, data processing apparatus. In addition, the one or more computer program products can be tangibly encoded in a propagated signal, which is an artificially generated signal, e.g., a machine-generated electrical, optical, or electromagnetic signal, that is generated to encode information for transmission to suitable receiver apparatus for execution by a computer. The computer readable storage device can be a machine-readable storage device, a machine-readable storage substrate, a memory device, or a combination of one or more of them.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, a cross-platform runtime environment, or a combination of one or more of them. In addition, the apparatus can employ various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a readonly memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, mobile device, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CDROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations of the subject matter described in this specification can be implemented in a computing system that includes a backend component, e.g., as a data server, or that includes a middleware component, e.g., an application server, or that includes a front end component, e.g., a client computer having a graphical user interface or a Web browser through which a user can interact with an implementation of the subject matter described is this specification, or any combination of one or more such backend, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other.

While this specification contains many implementation details, these should not be construed as limitations on the scope of the invention or of what may be claimed, but rather as descriptions of features specific to particular implementations of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the invention have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

1. A method comprising:
detecting a location of a mobile device having an installed application, wherein the installed application is associated with a media download system;
determining that the location satisfies predetermined criteria associated with a location of a download station of the media download system;
sending a message to the mobile device, wherein the message is adapted to cause a notification to be displayed on the mobile device of a proximity of the mobile device to the download station;
authenticating the mobile device with the media download system over a wireless local area network supported by the download station; and
initiating a download of one or more media files from the download station to the mobile device in response to at least authenticating the mobile device.

2. The method of claim 1 wherein the location of the mobile device is reported to the media download system using the installed application on the mobile device.

3. The method of claim 1 wherein the location is detected based on data reported by the installed application over a communication network.

4. The method of claim 1 wherein the predetermined criteria includes the mobile station being less than a threshold distance between the mobile device and the download station.

5. The method of claim 1 wherein the message is received by the installed application and the notification is displayed on the mobile device using the installed application.

6. The method of claim 1 wherein the notification includes information identifying a location of the download station.

7. The method of claim 1 wherein the installed application is associated with a user account and information associated with the user account identifies media content previously selected by a user of the user account, the method further comprising identifying one or more media files available on the download station that correspond to media content identified in the information associated with the user account.

8. The method of claim 7 wherein the message identifies the one or more available media files.

9. The method of claim 1 wherein authenticating the mobile device with the media download system over the wireless local area network is performed in response to detecting the mobile device as being within a communication range of the wireless local area network supported by the download station.

10. The method of claim 1 wherein initiating a download of one or more media files from the download station to the mobile device is further performed in response to receiving a request through the installed application on the mobile device to download one or more selected media files.

11. The method of claim 1 wherein the installed application is adapted to detect the wireless local area network and identify the wireless local area network as being associated with the media download system.

12. The method of claim 1, further comprising:
providing the installed application with access, over the wireless local area network, to metadata associated with media content available on the download station; and
displaying a listing of the available media content on a user interface of the mobile device using the installed application.

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. A system comprising:
a charging station including a plurality of charging ports adapted to charge batteries on mobile devices; and
a charging server associated with the charging station, wherein the charging server is adapted to:
confirm whether a mobile device in communication with the charging server has a predetermined application installed on the mobile device;
receive an identification of one of the plurality of charging ports from the mobile device; and
switch a charging rate on the identified charging port to a faster charging rate in response to confirming that the predetermined application is installed on the mobile device and receiving the identification of the charging port.

29. The system of claim 28 further comprising a wireless local network router adapted to support communications between the mobile device and the charging server.

30. A method comprising:
receiving a request to download selected media content from a download station to a user device;
detecting a file system type for the user device after the user device is connected to a panel-mounted port of the download station;
identifying one of a plurality of solid state drives storing a media content file corresponding to the selected media content, with each solid state drive connected to a processor of the download station via a transfer bus supporting transfer rates of at least four gigabits per second;
transferring the media content file over the corresponding transfer bus to the processor; and
transferring the media content file to the user device in accordance with the detected file system type for the user device, wherein the media content file is transferred using a bus connecting the processor to the panel-mounted port and the bus supports a transfer rate of at least three gigabits per second.

31. The method of claim 30 wherein the request to download selected media content is initiated by a user through an interaction with a web page interface.

32. The method of claim 31 wherein the web page interface is presented on a display screen of the download station.

33. The method of claim 31 wherein the web page interface is presented on a user mobile device.

34. The method of claim 30 wherein the processor and the solid state drives are secured within a housing of the download station.

35. The method of claim 30 wherein transferring the media content file to the user device in accordance with the detected file system type for the user device includes segregating the media content file into blocks selected according to the detected file system type.

36. (canceled)

37. (canceled)
